(19) United States
(12) Patent Application Publication
(10) Pub. No.: US 2005/0021499 A1
(43) Pub. Date: Jan. 27, 2005

(54) Cluster-and descriptor-based recommendations

(75) Inventors: Paul S. Bradley, Seattle, WA (US); Usama M. Fayyad, Mercer Island, WA (US); Bassel Y. Ojjeh, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/926,691

(22) Filed: Aug. 26, 2004

Related U.S. Application Data
(63) Continuation of application No. 09/540,637, filed on Mar. 31, 2000.

(51) Int. Cl. G06F 7/00

(52) U.S. Cl. 707/1

(57) ABSTRACT

Cluster- and descriptor-based recommender systems are disclosed which can, for example, scale to voluminous data. The data is generally organized into records and items. In one embodiment, a method first consolidates the data into groups, such as clusters or descriptors. The method determines a predicted vote for a particular record and a particular item, using a similarity scoring approach, such as a likelihood similarity approach, or a correlation similarity approach, based on the groups. The predicted vote can then be output.

### CROSS REFRENCE TO RELATED APPLICATION(S)

This application is a continuation of U.S. patent application Ser. No. 09/540,637, filed Mar. 31, 2000.

### FIELD OF THE INVENTION

This invention relates generally to recommender systems, and more particularly to such systems that make predictions based on groups such as clusters and descriptors.

### BACKGROUND OF THE INVENTION

Recommender systems, also referred to as predictive or predictor systems, collaborative filtering systems, and document similarity engines, among other terms, typically target determining a set of items, such as products, articles, etc., to match users based on other users' preferences and selections. Usually, a query is stated in terms of what is known about a user, and recommendations are retrieved based on other users' preferences. Generally, a prediction is made based on retrieving the set of users that are similar to a user, and then basing the recommendation on a weighted score of the matches.

Recommender systems have traditionally been based on memory-intensive techniques, where it is assumed the data or a large indexing structure over them is loaded into memory. Such systems, for example, are used by Internet web sites, to predict what products a consumer will purchase, or what web sites a computer user will browse to next. With the increasing popularity of the Internet and electronic commerce, use of recommender systems will likely increase.

A difficulty with recommender systems is, however, that they do not scale well to large databases. Such systems may fail as the size of the data grows, such as the size of an electronic commerce store grows, the inventory grows, the site decides to add more usage data to the prediction data, etc. This results in prohibitively expensive load times, which may cause timeouts and other problems. The response times may also increase as the data increase, such that performance requirements begin to be violated. For these and other reasons, therefore, there is a need for the present invention.

### SUMMARY OF THE INVENTION

The invention relates to cluster- and descriptor-based recommender systems, so that they can, for example, scale to voluminous data. The data is generally organized into records and items. In one embodiment, a method first consolidates the data into groups, such as clusters or descriptors. The method determines a predicted vote for a particular record and a particular item, using a similarity scoring approach, such as a likelihood similarity scoring approach, or a correlation similarity scoring approach, based on the groups. The predicted vote is then output. For example, the output can be used to determine whether a particular user (represented by a record) is likely to purchase a particular product (represented by an item).

Embodiments of the invention provide for advantages not found within the prior art. Because the prediction is made based on models derived from the groups, embodiments can scale to data that is voluminous, since the data is first consolidated into groups and the models are used to derive predictions, requiring less memory. Thus, even if the size of a database is very large, accurate predictions can still be accomplished, while still maintaining performance.

The invention includes computer-implemented methods, machine-readable media, computerized systems, and computers of varying scopes. Other aspects, embodiments and advantages of the invention, beyond those described here, will become apparent by reading the detailed description and with reference to the drawings.

### BRIEF DESCRIPTION OF THE DRAWINGS

FIG. 1 is a diagram of an operating environment in conjunction with which embodiments of the invention can be practiced;

FIG. 2 is a diagram of representative data organized into records and dimensions in accordance with which embodiments of the invention can be practiced;

FIG. 3 is a diagram of a system including a recommender system in according to an embodiment of the invention;

FIG. 4 is a flowchart of a method according to one embodiment of the invention.

### DETAILED DESCRIPTION OF THE INVENTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as processing or computing or calculating or determining or displaying or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Operating Environment

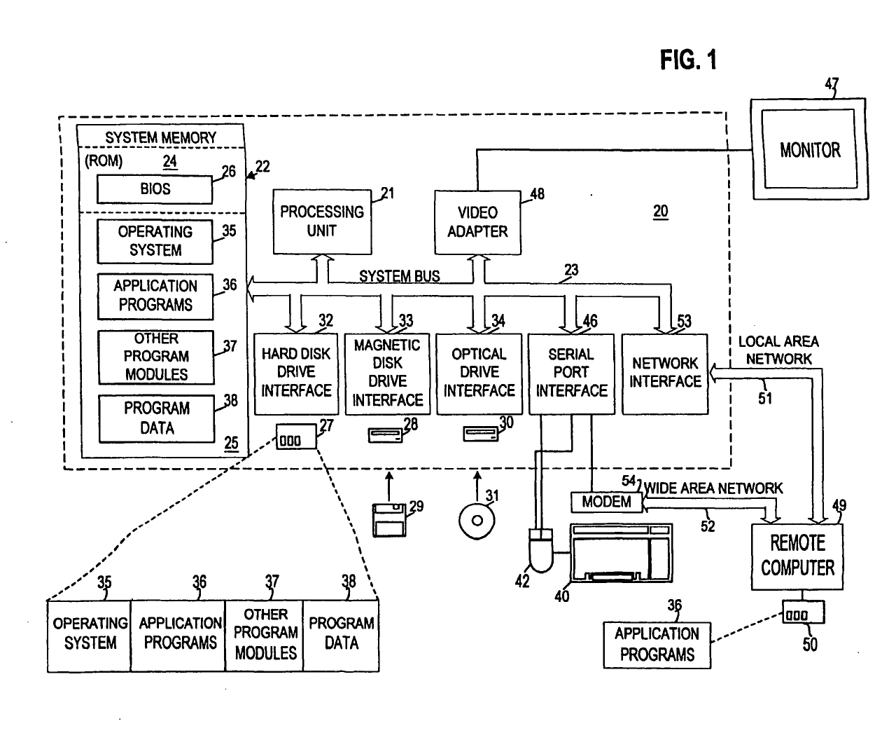

Referring to FIG. 1, a diagram of the hardware and operating environment in conjunction with which embodiments of the invention may be practiced is shown. The description of FIG. 1 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PC's, minicomputers, mainframe computers, ASICs (Application Specific Integrated Circuits), and the like. The invention may also be practiced in distributed computing environments where tasks are performed by remote processing devices that are linked through a communications network. In a distributed computing environment, program modules may be located in both local and remote memory storage devices.

The exemplary hardware and operating environment of FIG. 1 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, video camera, or the like. These and other input devices are often connected to the processing unit 21 through a serial port interface 46 that is coupled to the system bus, but may be connected by other interfaces, such as a parallel port, game port, an IEEE 1394 port (also known as FireWire), or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

Data Organized into Records and Dimensions

In this section of the detailed description, transactional data is described, in conjunction with which embodiments of the invention may be practiced. The transactional binary data is one type of data, organized into records and dimensions, in accordance with which embodiments of the invention may be practiced. It is noted, however, that the invention is not limited to application to transactional binary data. In other embodiments, count data, categorical discrete data, and continuous data, are amenable to embodiments of the invention.

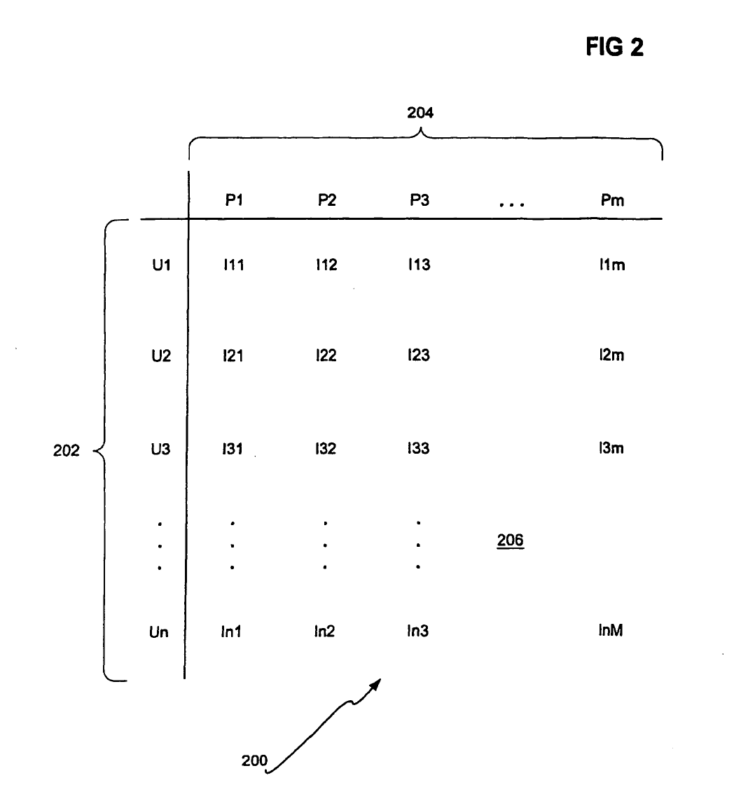

Referring to FIG. 2, a diagram of transactional binary data in conjunction with which embodiments of the invention may be practiced is shown. The data 206 is organized in a chart 200, with rows 202 and columns 204. Each row, also referred to as a record, in the diagram of FIG. 2 may correspond to a user, for example, users 1 . . . n. Each column, also referred to as a dimension or an item, may corresponds to a product, for example, products 1 . . . m. Each data point within the data 206 may correspond to whether the user has purchased the particular product, and is a binary value, where 1 corresponds to the user having purchased the particular product, and 0 corresponds to the user not having purchased the particular product. The data is not limited to this example where records are analogous to users and dimensions or columns are analogous to products. Following this example, though, I23 corresponds to whether user 2 has purchased product 3, In2 corresponds to whether user n has purchased item 2, I1m corresponds to whether user 1 has purchased item m, and Inm corresponds to whether user n has purchased item m.

The data 206 is referred to as sparse, because most data points have the value 0. In our example, a value of 0 indicates the fact that for any particular user, the user has likely not purchased a given product. The data 206 is binary in that each item can have either the value 0 or the value 1. The data 206 is transactional in that the data was acquired by logging transactions (for example, logging users' purchasing activity over a given period of time). It is noted that the particular correspondence of the rows 202 to users, and of the columns 204 to products, is for representative example purposes only, and does not represent a limitation on the invention itself. For example, the columns 204 in other embodiment could represent web pages that the users have viewed. In general, the rows 202 and the columns 204 can refer to any type of features. The columns 204 are interchangeably referred to herein as dimensions. Furthermore, it is noted that in large databases, the values n for the number of rows 202 could be on the order of hundreds of thousands to hundreds of millions, and m for the number of columns 204 can be on the order of tens of thousands to millions, if not more.

It is further noted that embodiments of the invention are not limited to any particular type of data. In some embodiments, the applications include data mining, data analysis in general, data visualization, sampling, indexing, prediction, and compression. Specific applications in data mining include marketing, fraud detection (in credit cards, banking, and telecommunications), customer retention and churn minimization (in all sorts of services including airlines, telecommunication services, internet services, and web information services in general), direct marketing on the web and live marketing in electronic commerce.

Recommender Systems

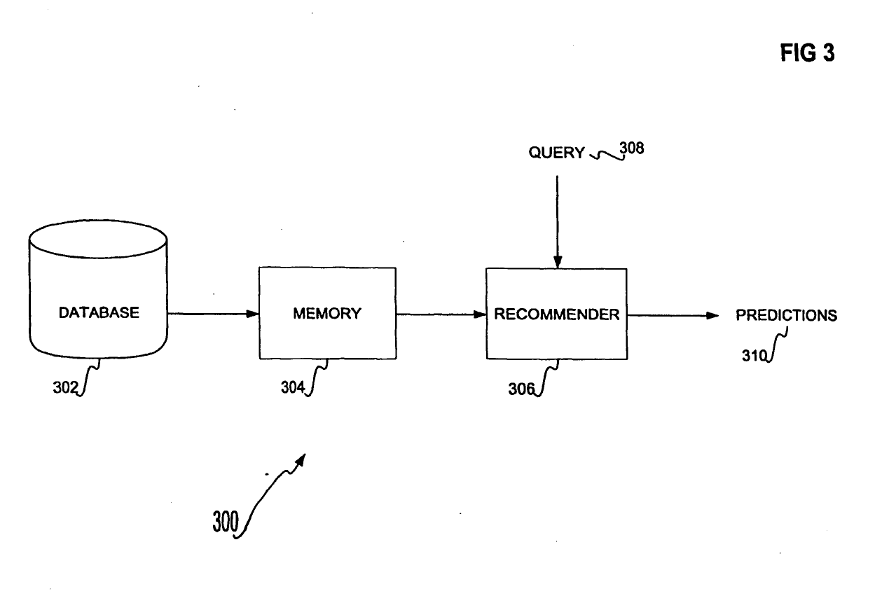

In this section of the detailed description, an overview of recommender systems according to embodiments of the invention are described. In FIG. 3, a diagram of a recommender system, according to an embodiment of the invention, is shown. The system 300 includes a database 302, a memory 304, and a recommender 306. The system 300 in one embodiment can be implemented within an operating environment such as has been described in conjunction with FIG. 1 in a preceding section of the detailed description. Typically and/or frequently, the size of the data within the database 302 is greater than the size of the memory 304.

The recommender system 306 generates or provides predictions 310 based on the query 308 and the data within the database 302, as known within the art. For example, the data can be organized into rows and dimensions, as described in the previous section of the detailed description, such that the query 308 can be likened to another record containing data relating to a number of dimensions, such that the predictions 310 include other dimensions (predicted) based on analyzing the query 308 against the data within the database 302, as is known within the art. For example, where the rows of the data correspond to consumers, and the dimensions of the data correspond to products purchased thereby, the query 308 can list the products already purchased by a particular consumer and request predictions 310 corresponding to other products the consumer is also likely to purchase given the products that have already been purchased, based on analysis by the recommender 306 comparing the query 308 to the data within the database 302.

Cluster-Based Approach

In this section of the detailed description, the manner by which predictions are made using a cluster-based approach, according to an embodiment of the invention, is described. In particular, the utility of an item for a particular user is predicted based upon other items of interest to this user, and data on the utility of items of interest over the data set (also referred to as the population). The data, such as a data set described in a preceding section of the detailed description, is assumed to have already been consolidated into clusters, as is known within the art. A cluster is generally defined as follows. A cluster v is a real-value vector with d elements, each element taking a value in range [0,1]. The value of vⱼ indicates the probability of observing item j over a segment (cluster) of the population. Sparse storage is possible for ε≧vⱼ, for some small ε greater than or equal to 0 (e.g. ε=0.0001). Each cluster has associated with it a support value, denoted as s(v) representing the number of population members in cluster v.

Two particular cluster-based approaches are described: a likelihood similarity scoring approach, and a correlation similarity scoring approach. For both, the following nomenclature is used. It is assumed that the predicted vote of the active user for item j, p_{a,j}, is a weighted sum of votes of other users as summarized by the k clusters. The predicted vote means the prediction of whether the user a will activate, effect, purchase, view, or otherwise cause the value of j for a—that is, the data point defined by row a and column j within the data—to be non-zero. For the “active” user a, let Iₐ be the set of items which a has voted (e.g. the set of items purchased by user a). For cluster i, let Iᵢ be the set of items that occur in the cluster i with non-zero probability. The probability of observing a 1 for item j in cluster i is denoted as v_{i,j}.

The likelihood similarity scoring approach for the cluster-based approach is now described. Thus, in one embodiment, the goal is to make a prediction regarding whether the “active” user a will buy product P, for example. (It is noted that while this description is made with specific reference to an embodiment relating to data including users and products that they can purchase, the invention itself is not so limited.) A prediction is made for products that the active user has not yet purchased, and list of items not purchased is then ranked by the prediction value and return the top N predictions. For the likelihood-based prediction variant, the degree of “similarity” between user a and cluster i is determined

$$w ( a , i ) = \frac{{\prod }_{j ∈ {I}_{a}} {f}_{j} \cdot {v}_{i , j}}{{\sum }_{h = 1}^{k} [ {\prod }_{j ∈ {I}_{a}} {f}_{j} \cdot {v}_{i , j} ]} . \qquad ( 1 )$$

In equation (1), fⱼ is a general weight on the j-th data attribute. In the case where fⱼ is equal to 1 for all attributes j, then w(a,i) is the probability that the i-th cluster generated the data record of the active user a. Another choice for fⱼ is to use a function of the inverse frequency of the attribute:

$${f}_{j} = [ log ( \frac{n}{{n}_{j}} ) + 1 ] , {n}_{j} = {\sum }_{h = 1}^{k} s ( {v}_{h} ) \cdot {v}_{h , j} . \qquad ( 2 )$$

In equation (2), nⱼ is the number of attributes in the database having a value for attributed and is computed by summing the number of data points in cluster h(S(vₕ)) multiplied by the probability of observing attribute j in cluster h(v_{h,j}). Then the predicted value for product P for the “active” user a is:

$${p}_{a , P} = {\sum }_{h = 1}^{k} ( \frac{s ( {v}_{h} )}{m} ) \cdot w ( a , h ) \cdot {v}_{h , P} . \qquad ( 3 )$$

In equation (3), m is the total number of data records in the database. The fraction s(vₕ)/m is the probability that cluster h generates a data record.

Next, the correlation similarity scoring approach for a cluster-based approach is described. The description herein again specifically relates to an embodiment of the invention in which purchase predictions are made for users of products; however, the invention itself is not so limited. It is again assumed that the predicted vote of the active user for product P, P_{a,P}, is a weighted sum of votes of other users as summarized by the k clusters. For the “active” user a, let Iₐ be the set of items which a has voted (e.g. the set of products that user a has purchased). The mean vote for a is defined as:

$${\overline{v}}_{a} = \frac{1}{\vert {I}_{a} \vert} {\sum }_{j ∈ {I}_{a}} {v}_{a , j} . \qquad ( 4 )$$

Note that if user a votes with value 1, then \overline{v}ₐ=1. For cluster i, let Iᵢ be the set of items that occur in the cluster i with non-zero probability. It has been previously noted the probability of observing a 1 for item j in cluster i is denoted as v_{i,j}. The mean vote for cluster i is then:

$${\overline{v}}_{i} = \frac{1}{\vert {I}_{i} \vert} {\sum }_{j ∈ {I}_{i}} {v}_{i , j} . \qquad ( 5 )$$

Thus, the predicted vote of the active user for item j is:

$${p}_{a , P} = {\overline{v}}_{a} + κ {\sum }_{i = 1}^{k} w ( a , i ) \cdot s ( {v}_{i} ) \cdot ( {v}_{i , P} - {\overline{v}}_{i} ) . \qquad ( 6 )$$

The weights w(a,i) reflect correlation, distance or similarity between cluster i and the active user a. The value of K is such that the values of the weights times support sum to 1:

$$κ = \frac{1}{{\sum }_{i = 1}^{k} w ( a , i ) \cdot s ( {v}_{i} )} . \qquad ( 7 )$$

To determine the similarity of the data record for the active user a and cluster i, the inverse user frequency formula is changed slightly:

$${f}_{j} = log ( \frac{n}{{n}_{j}} ) , {n}_{j} = {\sum }_{i = 1}^{k} s ( {v}_{i} ) \cdot {v}_{i , j} . \qquad ( 8 )$$

In equation (8), nⱼ is the number of users in the database (consolidated into clusters) which “voted” or “chose” attribute j. The value of nⱼ is determined as the sum over clusters of the number of points in each cluster times the probability of observing attribute j in the cluster. The value of n is the total number of records in the database. The value fⱼ is the log of the “inverse user frequency”. If attributed is chosen by everyone in the database, then nⱼ=n and fⱼ=log(1)=0. A higher value of fⱼ assigns more weight in the calculation of w(a,i). The value of w(a,i) is:

$$w ( a , i ) = \frac{( {\sum }_{j = 1}^{d} {f}_{j} ) ( {\sum }_{j = 1}^{d} {f}_{j} \cdot {v}_{a , j} \cdot {v}_{i , j} ) - ( {\sum }_{j = 1}^{d} {f}_{j} \cdot {v}_{a , j} ) ( {\sum }_{j = 1}^{d} {f}_{j} \cdot {v}_{i , j} )}{\sqrt{U \cdot V}} , \\ U = ( {\sum }_{j = 1}^{d} {f}_{j} ) ( {\sum }_{j = 1}^{d} {f}_{j} \cdot {v}_{a , j}^{2} ) - {( {\sum }_{j = 1}^{d} {f}_{j} \cdot {v}_{a , j} )}^{2} , \\ V = ( {\sum }_{j = 1}^{d} {f}_{j} ) ( {\sum }_{j = 1}^{d} {f}_{j} \cdot {v}_{i , j}^{2} ) - {( {\sum }_{j = 1}^{d} {f}_{j} \cdot {v}_{i , j} )}^{2} . \qquad ( 9 )$$

Descriptor-Based Approach

In this section of the detailed description, the manner by which predictions are made using a descriptor-based approach, according to an embodiment of the invention, is described. In particular, the utility of an item for a particular user is predicted based upon other items of interest to this user, and data on the utility of items of interest over the data set (also referred to as the population). The data, such as a data set described in a preceding section of the detailed description, is assumed to have already been consolidated into descriptors, as is known within the art. A descriptor is generally defined as follows. A descriptor v is a bit-vector (binary-valued vector) with d elements (vε{0,1}^{d}). Each descriptor has associated with it a support value, denoted as s(v) representing the count of population members satisfying the description v (possibly with some error).

One particular descriptor-based approach is described, a correlation similarity scoring approach. The following nomenclature is again used. It is assumed that the predicted vote of the active user for item j, p_{a,j}, is a weighted sum of votes of other users as summarized by the k descriptors. The predicted vote means the prediction of whether the user a will activate, effect, purchase, view, or otherwise cause the value of j for a—that is, the data point defined by row a and column j within the data—to be non-zero. For the “active” user a, let Iₐ be the set of items which a has voted (e.g. the set of products purchased by user a). For descriptor i, let Iᵢ bet the set of items that occur in the descriptor i with non-zero value. The value for item j in descriptor i is denoted as v_{i,j}, (recall that v_{i,j} has value 1 if item j occurs in descriptor i and has value 0 if item j does not occur in descriptor i). The description herein again specifically relates to an embodiment of the invention in which purchase predictions are made for users of products; however, the invention itself is not so limited.

The correlation similarity scoring approach for descriptors is identical to the correlation similarity scoring approach for clusters described in the previous section of the detailed description, in conjunction with equations (4)-(9), with two simplifications. The first simplification is that \overline{v}ₐ and \overline{v}ᵢ are 1. Hence p_{a,j}, simplifies to

$${p}_{a , j} = 1 + κ {\sum }_{i = 1}^{k} w ( a , i ) \cdot s ( {v}_{i} ) \cdot ( {v}_{i , j} - 1 ) . \qquad ( 10 )$$

Since v_{i,j} is either 0 or 1, expression is simplified as:

$${p}_{a , j} = 1 - κ {\sum }_{\{ {v}_{i} \vert {v}_{i , j} = 0 \}}^{} w ( a , i ) \cdot s ( {v}_{i} ) . \qquad ( 11 )$$

The determination of w(a,i) is the same as that described in conjunction with the correlation similarity scoring approach for clusters in the previous section of the detailed description. Here nⱼ is the number of users in the database (as summarized by the descriptors) which “voted” or “chose” attributed. The value of nⱼ is specifically determined as follows. First, the set of descriptors that have value “1” for attributed is determined. The value of nⱼ is the sum of the support of each of these descriptors having a “1” in attribute j. The value of n is the total number of records in the database. The value fⱼ is the log of the “inverse user frequency”. If attribute j is chosen by everyone in the database, then nⱼ=n and fⱼ=log(1)=0. A higher value of fⱼ assigns more weight in the calculation of w(a,i).

Methods

In this section of the detailed description, methods according to varying embodiments of the invention are described. In some embodiments, the methods can be computer-implemented. The computer-implemented methods are desirably realized at least in part as one or more programs running on a computer—that is, as a program executed from a computer-readable medium such as a memory by a processor of a computer. The programs are desirably storable on a machine-readable medium such as a floppy disk or a CD-ROM, for distribution and installation and execution on another computer.

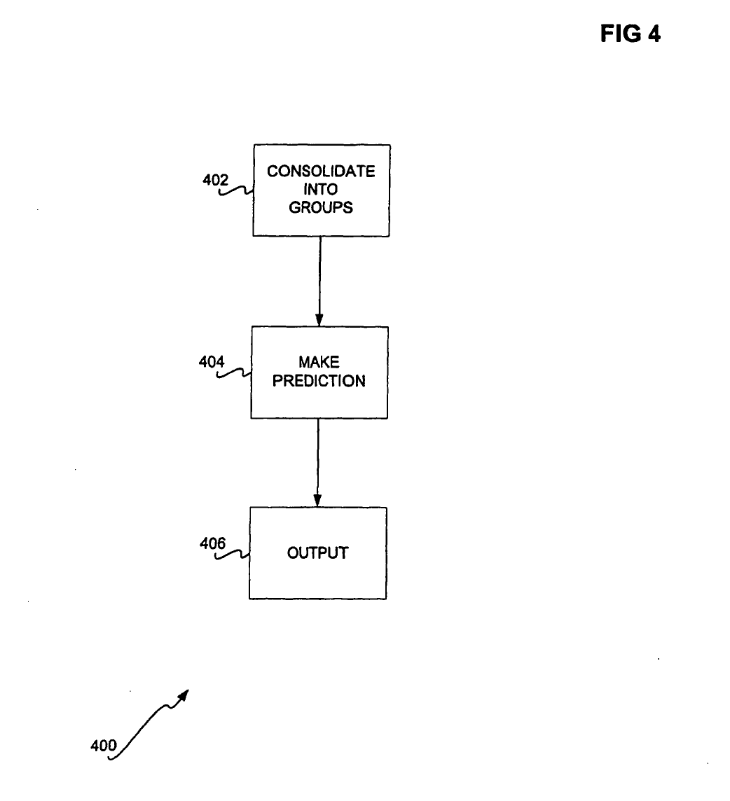

Referring to FIG. 4, a flowchart of a method 400 according to an embodiment of the invention is shown. In 402, data organized into records (i.e., users or rows) and items (i.e., columns or dimensions), such that each record has a value for each item, is consolidated into groups, such as clusters or descriptors. The invention is not limited to a particular manner by which such consolidation is performed, and various descriptor-grouping and clustering techniques are known within the art.

In 404, a prediction is made, based on the groups into which the data has been consolidated. In particular, a predicted vote is determined for a particular record and a particular item, using a similarity scoring approach, such as has been described in the previous two sections of the detailed description. For groups that are clusters, the similarity scoring approach can be, for example, a likelihood similarity scoring approach or a correlation similarity scoring approach. For groups that are descriptors, the similarity scoring approach can be, for example, a correlation similarity scoring approach. Thus, where each record corresponds to a user, and each item corresponds to a product, determining the predicted vote means determining whether a particular user will purchase a particular product. As another example, where each record corresponds to a user, and each item corresponds to a web page, determining the predicted vote means determining whether a particular user will view a particular web page.

Finally, in 406, the determined vote is output. The invention is not limited to the manner by which output is accomplished. For example, in one embodiment, output can be to a computer program or software component. As another example, output can be displayed on a displayed device, or printed to a printer, etc. As a third example, output can be stored on a storage device, etc.

### CONCLUSION

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the following claims and equivalents thereof.

1. A computer-implemented method comprising:
consolidating data organized into records and items, such that each record has a value for each item, into a plurality of groups;
based on the plurality of groups, determining a predicted vote for a particular record and a particular item using a similarity scoring approach; and,
outputting the predicted vote for the particular record and the particular item.

2. The method of claim 1, wherein consolidating the data into the plurality of groups comprises consolidating the data into a plurality of clusters.

3. The method of claim 1, wherein consolidating the data into the plurality of groups comprises consolidating the data into a plurality of descriptors.

4. The method of claim 1, wherein each record is referred to as at least one of: a row, and a user.

5. The method of claim 1, wherein each item is referred to as at least one of: a column, and a dimension.

6. The method of claim 1, wherein each record comprises a user, and each item comprises a product, such that determining the predicted vote for the particular record and the particular item comprises determining whether a particular user will purchase a particular product.

7. The method of claim 1, wherein each record comprises a user, and each item comprises a web page, such that determining the predicted vote for the particular record and the particular item comprises determining whether a particular user will view a particular web page.

8. The method of claim 1, wherein the similarity scoring approach comprises a likelihood similarity scoring approach.

9. The method of claim 1, wherein the similarity scoring approach comprises a correlation similarity scoring approach.

10. A machine-readable medium having instructions stored thereon for execution by a processor to perform a method comprising:
consolidating data organized into records and items, such that each record has a value for each item, into a plurality of groups; and,
based on the plurality of groups, determining a predicted vote for a particular record and a particular item using a similarity scoring approach.

11. The medium of claim 10, the method further comprising outputting the predicted vote for the particular record and the particular item.

12. The medium of claim 10, wherein consolidating the data into the plurality of groups comprises consolidating the data into one of: a plurality of clusters, and a plurality of descriptors.

13. The medium of claim 10, wherein each record is referred to as at least one of: a row, and a user.

14. The medium of claim 10, wherein each item is referred to as at least one of: a column, and a dimension.

15. The medium of claim 10, wherein the similarity scoring approach comprises one of: a likelihood similarity scoring approach, and a correlation similarity scoring approach.

16. A computer-implemented method operable on data organized into records and items, such each record has a value for each item, the data also consolidated into a plurality of clusters, the method comprising:
based on the plurality of clusters, determining a predicted vote for a particular record and a particular item using a similarity scoring approach; and,
outputting the predicted vote for the particular record and the particular item.

17. The method of claim 16, wherein each record comprises a user, and each item comprises a product, such that determining the predicted vote for the particular record and the particular item comprises determining whether a particular user will purchase a particular product.

18. The method of claim 16, wherein each record comprises a user, and each item comprises a web page, such that determining the predicted vote for the particular record and the particular item comprises determining whether a particular user will view a particular web page.

19. The method of claim 16, wherein the similarity scoring approach comprises one of: a likelihood similarity scoring approach, and a correlation similarity scoring approach.

20. A computer-implemented method operable on data organized into records and items, such each record has a value for each item, the data also consolidated into a plurality of clusters, the method comprising:
based on the plurality of descriptors, determining a predicted vote for a particular record and a particular item using a similarity scoring approach; and,
outputting the predicted vote for the particular record and the particular item.

21. The method of claim 20, wherein each record comprises a user, and each item comprises a product, such that determining the predicted vote for the particular record and the particular item comprises determining whether a particular user will purchase a particular product.

22. The method of claim 20, wherein each record comprises a user, and each item comprises a web page, such that determining the predicted vote for the particular record and the particular item comprises determining whether a particular user will view a particular web page.

23. The method of claim 20, wherein the similarity scoring approach comprises correlation similarity scoring approach.

24. A computer-implemented method comprising:
consolidating data organized into records and items, such that each record has a value for each item, into a plurality of groups summarized by a plurality of models wherein a model for a group is defined by a plurality of data points having a value in a range and that are determined from a plurality of data records from the group which indicate a probability of observing a value of one for an item within the group;
based on the plurality of groups, determining a predicted vote for a particular record and a particular item using a similarity scoring approach that reflects likelihood similarity between one model that summarizes one group of the plurality of groups and the particular record; and
outputting the predicted vote for the particular record and the particular item.

25. The method of claim 24, wherein consolidating the data into the plurality of groups comprises consolidating the data into a plurality of clusters.

26. The method of claim 24, wherein consolidating the data into the plurality of groups comprises consolidating the data into a plurality of descriptors.

27. The method of claim 24, wherein each record is referred to as at least one of: a row, and a user.

28. The method of claim 24, wherein each item is referred to as at least one of: a column, and a dimension.

29. The method of claim 24, wherein each record comprises a user, and each item comprises a product, such that determining the predicted vote for the particular record and the particular item comprises determining whether a particular user will purchase a particular product.

30. The method of claim 24, wherein each record comprises a user, and each item comprises a web page, such that determining the predicted vote for the particular record and the particular item comprises determining whether a particular user will view a particular web page.

31. A computer-readable medium having instructions stored thereon for execution by a processor to perform a method comprising:
consolidating data organized into records and items, such that each record has a value for each item, into a plurality of groups summarized by a plurality of models wherein a model for a group is defined by a plurality of data elements having a value in a range and that are determined from a plurality of data records from the group which indicate a probability of observing a value of one for an item within the group; and
based on the plurality of groups, determining a predicted vote for a particular record and a particular item using a likelihood similarity scoring or a correlation similarity scoring between the particular record and one model that summarizes one group of the plurality of groups.

32. The medium of claim 31, the method further comprising outputting the predicted vote for the particular record and the particular ite m.

33. The medium of claim 31, wherein consolidating the data into the plurality of groups comprises consolidating the data into one of: a plurality of clusters, and a plurality of descriptors.

34. The medium of claim 31, wherein each record is referred to as at least one of: a row, and a user.

35. The medium of claim 31, wherein each item is referred to as at least one of: a column, and a dimension.

36. A computer-implemented method operable on data organized into records and items, such each record has a value for each item, the data also consolidated into a plurality of clusters summarized by a plurality of models wherein a model for a cluster is defined by a plurality of data elements having a value in the range and that are determined from a plurality of data records from the cluster which indicate a probability of observing a value of one for an item within the group the method comprising:
based on the plurality of clusters, determining a predicted vote for a particular record and a particular item using a likelihood similarity scoring or a correlation similarity scoring between the particular record and one model that summarizes one cluster of the plurality of clusters; and
outputting the predicted vote for the particular record and the particular item.

37. The method of claim 36, wherein each record comprises a user, and each item comprises a product, such that determining the predicted vote for the particular record and the particular item comprises determining whether a particular user will purchase a particular product.

38. The method of claim 36, wherein each record comprises a user, and each item comprises a web page, such that determining the predicted vote for the particular record and the particular item comprises determining whether a particular user will view a particular web page.

39. A computer-implemented method operable on data organized into records and items, such each record has a value for each item, the data also consolidated into a plurality of descriptors summarized by a plurality of models wherein a model for a descriptor comprises a plurality of data elements having a value in a range and that are determined from a plurality of data records that define the descriptor which indicate a probability of observing a value of one for an item, the method comprising:
based on the plurality of descriptors, determining a predicted vote for a particular record and a particular item using a correlation similarity scoring that finds a similarity between the particular record and one model that summarizes one descriptor of the plurality of descriptors; and
outputting the predicted vote for the particular record and the particular item.

40. The method of claim 39, wherein each record comprises a user, and each item comprises a product, such that determining the predicted vote for the particular record and the particular item comprises determining whether a particular user will purchase a particular product.

41. The method of claim 39, wherein each record comprises a user, and each item comprises a web page, such that determining the predicted vote for the particular record and the particular item comprises determining whether a particular user will view a particular web page.

42. The method of claim 24 wherein the particular record is contained within the records that are organized into groups and wherein a probability that a given group contains the particular record is used to reflect likelihood similarity.

43. The computer-readable medium of claim 31 wherein the particular record is contained within the records that are organized into groups and wherein a probability that a given group contains the particular record is used as the correlation similarity.

44. The method of claim 36 wherein the particular record is contained within the records that are consolidated into clusters and wherein a probability that a given cluster contains the particular record is used to reflect correlation similarity scoring.

45. The computer implemented method of claim 39 wherein the particular record is contained within the records that are consolidated into clusters and wherein a probability that a given cluster contains the particular record is used to find similarity between the particular record and one of the plurality of clusters.

46. A computer-implemented method comprising:
consolidating data organized into records and items, such that each record has a value for each item, into a plurality of groups summarized by a plurality of models wherein said probability model for a group comprises a plurality of data elements having a value in a range and that are determined from a plurality of data records that define the group which indicate a probability of observing a value;
based on the plurality of groups, determining a predicted vote for a particular record and a particular item using a similarity scoring approach that reflects correlation similarity between one model that summarizes one group of the plurality of groups and the particular record; and
outputting the predicted vote for the particular record and the particular item.

47. The method of claim 24, wherein said probability model for a group is defined by a plurality of data points having a value in the range of (0,1)

48. The computer readable medium of claim 31, wherein said probability model for a group is defined by a plurality of data elements having a value in the range of (0,1).

49. The method of claim 36, wherein said probability model for a cluster is defined by a plurality of data elements having a value in the range of (0,1).

50. The method of claim 39, wherein said probability model foray descriptor comprises a plurality of data elements having a value in the range of (0,1).

51. The method of claim 46, wherein said probability model for a group comprises a plurality of data elements having a value in the range of (0, 1).
